(19) United States
(12) Patent Application Publication
(10) Pub. No.: US 2023/0229509 A1
(43) Pub. Date: Jul. 20, 2023

(54) CONFIGURING A RESOURCE FOR EXECUTING A COMPUTATIONAL OPERATION

(71) Applicant: Telefonaktiebolaget LM Ericsson (PUBL), Stockholm (SE)

(72) Inventors: Edgar Ramos, KIRKKONUMMI (FI); Ari Keränen, HELSINKI (FI); Boris Plenkov, ESPOO (FI); Joel Reijonen, KIRKKONUMMI (FI); Miljenko Opsenica, ESPOO (FI)

(21) Appl. No.: 17/998,168

(22) PCT Filed: May 8, 2020
(86) PCT No.: PCT/SE2020/050477

§ 371 Date: Nov. 8, 2022

(51) Int. Cl. G06F 9/50; G06F 9/445

(52) U.S. Cl. CPC G06F 9/5033; G06F 9/44505

(57) ABSTRACT

A computing node is disclosed. The computing node comprises processing circuitry configured to cause the computing node to receive a message (102) comprising configuration information for a resource of a data object that is hosted at the computing node and is associated with a computational operation, which computational operation is executable by the computing node. The processing circuitry is further configured to cause the computing node to configure (104) the resource of the data object on the computing node in accordance with the received configuration information, and to execute (106) the computational operation in accordance with the configured resource. Also disclosed are a corresponding server node and methods of operating a computing node and a server node. The computing node may comprise a Lightweight Machine to Machine (LwM2M) client and the server node may comprise an LwM2M server.

### TECHNICAL FIELD

The present disclosure relates to a computing node, and to a server node. The present disclosure also relates to methods for operating a computing node and a server node, and to corresponding computer programs, carriers, and computer program products.

### BACKGROUND

Computational models may be used by a device to enable new or enhanced functionality, for example through machine learning and/or decision making. Machine Learning (ML) refers to the use of algorithms and statistical models to perform a task, and generally involves a training phase, in which algorithms build a computational operation based on some sample input data, and an inference phase, in which the computational operation is used to make predictions or decisions without being explicitly programmed to perform the task. ML models are trained with system data that consists of past experiences, or is constructed from a set of examples. Decision making models may implement logic that selects an action upon the basis of predictions provided by an ML model. This is the domain of decision theory, control theory and game theory.

The idea of moving the execution of computational models from data centres and high-end computers to more constrained devices has become popular in recent years. Motivations for shifting the execution of such models to devices, which are closer to the source of the data on which they rely, include optimised performance of the computational models and decreased latency. Enabling the use of ML models, and other complex computational operations, in computationally constrained devices is consequently an important factor in facilitating the development of modern smart devices. For this reason, ML and related capabilities are currently compiled as a part of a smart device’s firmware.

It will be appreciated that updating an ML or other computational model may differ from a traditional firmware update in several respects. For example, a device using ML or other computational operations may update a computational operation independently using local data, so enabling a more personalised performance of the computational operation. In contrast, a traditional firmware update may typically be handled by the manufacturer of the device, and relate to improved performance that is generalised across a large number of devices, as opposed to being tailored to a specific device or system.

Requiring a full firmware update whenever a computational model in a device is changed or updated results in a large amount of data being transferred, and may require the device to be rebooted, with associated operational issues. Additionally, in contrast to conventional firmware updates that are applicable to a large number of devices, a firmware update for a computational model should be specific to a particular device type, in order to ensure access to the full range of device capabilities. For example, even if the same computational model is used on different types of device, updates to the model will have to be included as part of device-specific firmware for each device that requires updating, so as to contain code that is readable by the device and to ensure the correct data is used as inputs and/or provided as an output of the computational operation.

### SUMMARY

It is an aim of the present disclosure to provide a method, node and computer readable medium which at least partially address one or more of the challenges discussed above.

According to a first aspect of the present disclosure, there is provided a computing node comprising processing circuitry configured to cause the computing node to receive a message comprising configuration information for a resource of a data object that is hosted at the computing node and is associated with a computational operation, which computational operation is executable by the computing node. The processing circuitry is further configured to cause the computing node to configure the resource of the data object on the computing node in accordance with the received configuration information, and to execute the computational operation in accordance with the configured resource.

According to another aspect of the present disclosure, there is provided a server node comprising processing circuitry configured to cause the server node to generate configuration information for a resource of a data object that is hosted at a computing node and is associated with a computational operation, which computational operation is executable by the computing node. The processing circuitry is further configured to cause the server node to send to the computing node a message comprising the generated configuration information.

According to another aspect of the present disclosure, there is provided a method for operating a computing node. The method, performed by the computing node, comprises receiving a message comprising configuration information for a resource of a data object that is hosted at the computing node and is associated with a computational operation, which computational operation is executable by the computing node. The method further comprises configuring the resource of the data object on the computing node in accordance with the received configuration information, and executing the computational operation in accordance with the configured resource.

According to another aspect of the present disclosure, there is provided a method for operating a server node. The method, performed by the server node, comprises generating configuration information for a resource of a data object that is hosted at a computing node and is associated with a computational operation, which computational operation is executable by the computing node, and sending to the computing node a message comprising the generated configuration information.

According to another aspect of the present disclosure, there is provided a computer program comprising instructions which, when executed on at least one processor, cause the at least one processor to carry out a method according to any one of the aspects or examples of the present disclosure.

According to another aspect of the present disclosure, there is provided a carrier containing a computer program according to the preceding aspect of the present disclosure, wherein the carrier comprises one of an electronic signal, optical signal, radio signal or computer readable storage medium.

According to another aspect of the present disclosure, there is provided a computer program product comprising non transitory computer readable media having stored thereon a computer program according to a preceding aspect of the present disclosure.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flow chart illustrating process steps in a method for operating a computing node;

FIGS. 2a, 2b and 2c show a flow chart illustrating process steps in another example of method for operating a computing node;

FIG. 3 is a representation of resources that may be associated with a data object according to examples of the present disclosure;

FIG. 4 is a flow chart illustrating process steps in a method for operating a server node;

FIGS. 5a and 5b show a flow chart illustrating process steps in another example of method for operating a server node;

FIG. 6 is a signalling diagram illustrating processes between a computing device and a server node;

FIG. 7 is a block diagram illustrating functional modules in a computing node; and

FIG. 8 is a block diagram illustrating functional modules in a server node.

### DETAILED DESCRIPTION

Aspects of the present disclosure provide methods for operating a computing node, and for operating a server node, which methods may cooperate to enable the configuration of a computational operation to be executed by the computing node. The configuration is achieved via configuration of resources of a data object that is hosted at the computing node and associated with the computational operation to be executed by the computing node. Resources of the data object may be exposed by the computing node, and configuration information for the resources may be provided by the server node, allowing the server node to provision, update and otherwise configure the execution of the computational operation by the computing node. The computing node may be operable to run a Lightweight Machine to Machine (LwM2M) client, and the server node may be operable to run a LwM2M server. The data object that is hosted at the computing node and associated with the computational operation to be executed by the computing node may conform to an object model, which model may be specified as part of the LwM2M protocol specification, such that the data object comprises a LwM2M management object.

The LwM2M protocol is a device management protocol that is suitable for constrained computing nodes and networks. LwM2M may expose computing node capabilities using an object model, where a set of related capabilities are grouped together in data objects. Each data object comprises one or more resources, each resource having a value that can either be read from, or written to. For example, a value of a “current temperature” resource may comprise a current value of a temperature sensor at the computing node.

There now follows a brief discussion of resources that may be included in instances of the data object proposed according to examples of the present disclosure, followed by a presentation of methods that may be performed by a computing node and a server node, and which make use of such a data object.

A data object associated with a computational operation to be executed by a computing node in accordance with the present disclosure may have a range of resources. At least some resources may concern the computational operation itself. The computational operation may for example comprise an ML model, a decision making model, or any other computational operation. The computational operation may be a complex computational operation comprising for example a plurality of component primitive computational operations or combinations of primitive computational operations. Examples of primitive operations include ADD, AND, DIV, IF, MAX, MIN, MUL, NONZERO, NOT, OR, SUB, SUM, and XOR. The following description refers to a computational operation in the form of a “model”, but it will be understood that this is merely for the purposes of illustration. The resources concerning the model itself may include a “Model” resource, containing the model, “Model URI” resource, containing a location of the model, and/or “Model Description” resource, containing a description of the model, which may or may not be in an executable form. In some implementations, the model may be natively defined in the computing node, and a server node may therefore be operable only to enable and configure the model already available in the computing node. In other implementations a server may be operable to modify or define new models using description formats supported by the client or a code snap in a programming language supported by the computing node. Description formats may be based on computational graphs, such as the Open Neural Network Exchange (ONNX), first published in 2017 and available at https://github.com/onnx/onnx and https://onnx.ai/. In further implementations, the computing node may be provisioned with a reference to fetch the code of the model from a specific location.

Other resources that may be present in the data object hosted by the computing node may concern inputs to be processed by the model, as well as an indication of how the output or outputs should be treated. In some implementations, an output may be provided as a single response to a function call on the model. In other examples, an output may trigger the execution of another function, and/or some elements of the output may be used in a further function call. “Input” and “Input labels” resources may be used to configure where a model reads its input data from, and “Output” and “Output labels” resources may be used to configure where the model writes its output data. For example, models may be chained together by causing an output of one model to be used as input of another model.

Some models require an input to be prepared before being processed by the component operators of the model. “Input transform” resources may be used to perform such preparation. The preparation functions may be available either as native functions in the execution environment of the computing node, or they can be provided in a similar manner to the model itself (for example with a simplified scope). In further examples, the preparation functions may be delivered as an executable code through a redirection such a URL based API. Some preparation functions have a counterpart for post-processing, which may be applied to the output once the computational operation has been executed. Such counterparts can be provided using “Output transform” resources.

In some implementations, an orchestration of the model or models may imply conditional execution based on a given logic. This logic can be defined as any combination of Boolean expressions based on inputs and current state, and/or as a more complicated evaluation, including received commands. In further examples, a condition expression could direct a computing node to execute a different model, or lead to a redirection to a different resource, which may be in a different domain. These redirections may be indicated with a URL, for example.

Examples of a data object comprising one, some or all of the above discussed resources may be used in connection with methods performed by a computing node and a server node in accordance with examples of the present disclosure.

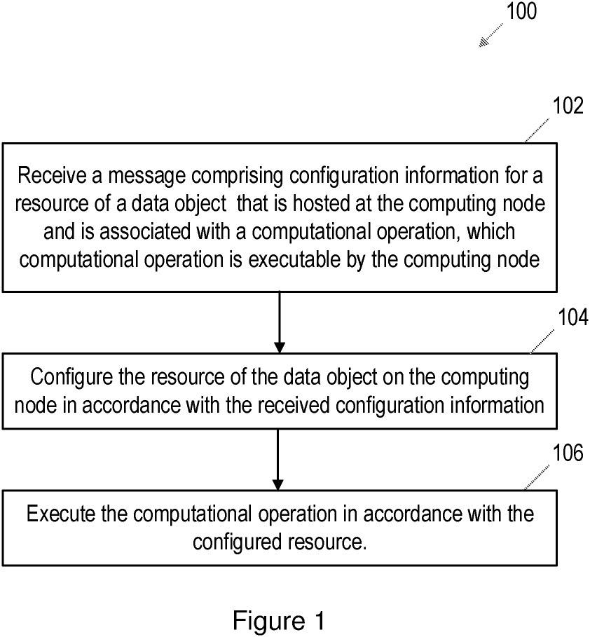

FIG. 1 is a flow chart illustrating process steps in a method 100 for operating a computing node in accordance with aspects of the present disclosure. The method is performed by the computing node, which may be operable to run a LwM2M client. The computing node may for example comprise a constrained node, as set out in RFC 7228.

Referring to FIG. 1, the method 100 comprises, in a first step 102, receiving a message comprising configuration information for a resource of a data object that is hosted at the computing node and is associated with a computational operation, which computational operation is executable by the computing node. It will be appreciated that the computational operation may comprise a complex computational operation such as a machine learning model, or a decision-making model, for example. The data object may conform to an object model that specifies resources that may be associated with instances of the data object. The object model to which the data object conforms may be specified as part of the LwM2M protocol specification, and the data object may comprise a LwM2M management object. In some examples, multiple instances of the data object may be hosted at the computing node, each instance of the data object being associated with a different computational operation.

In step 104, the method 100 comprises configuring the resource of the data object on the computing node in accordance with the received configuration information. It will be appreciated that, if the resource is already hosted at the computing node, the step of configuring the resource on the computing node may comprise updating a value of the resource in accordance with the received configuration information. Alternatively, if the resource does not already exist at the computing node, the step of configuring the resource on the computing node may comprise creating the resource on the computing node in accordance with the received configuration information.

In step 106, the method 100 comprises executing the computational operation in accordance with the configured resource. In some examples, the step of executing the computational operation in accordance with the configured resource may comprise executing the computational operation in accordance with all resources of the data object, including the configured resource.

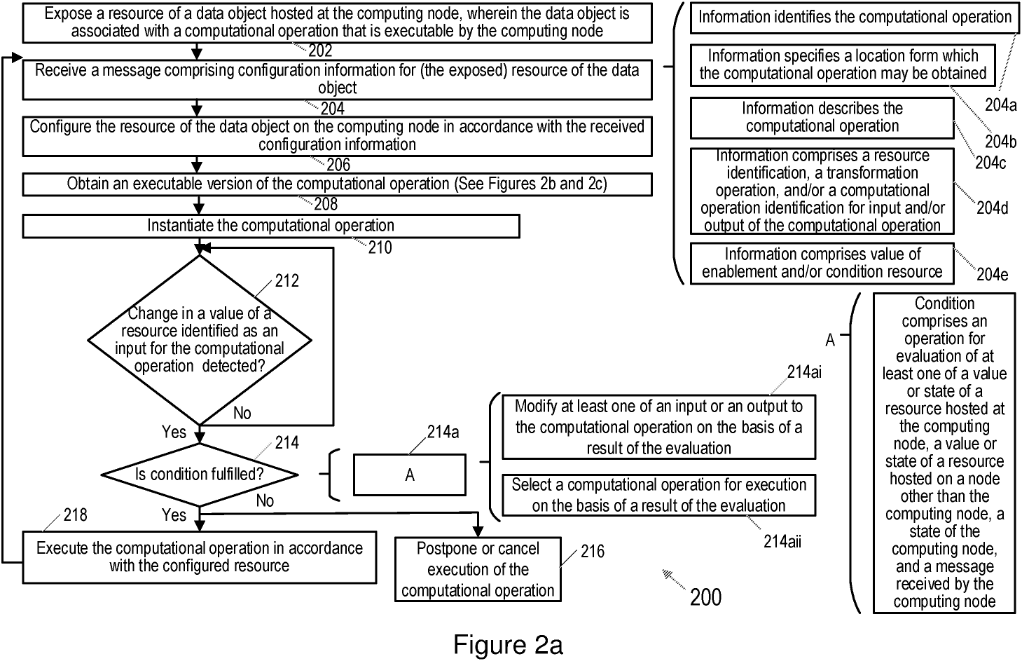

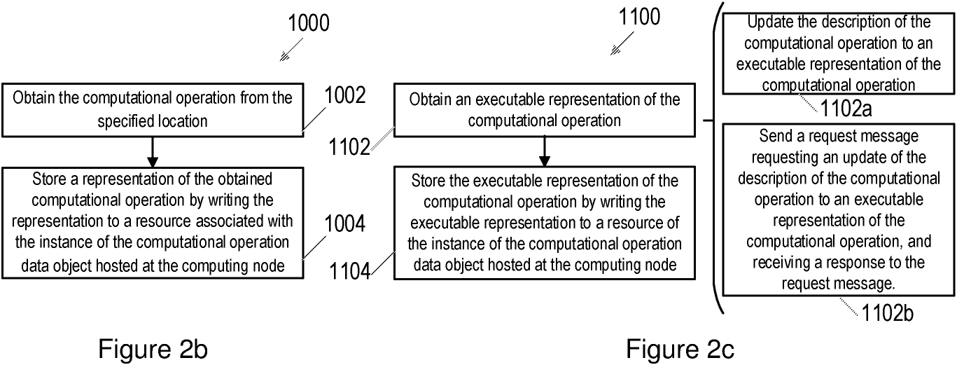

FIGS. 2a to 2c show a flow chart illustrating process steps in another example of a method 200 for operating a computing node in accordance with aspects of the present disclosure. The method 200 is performed by the computing node. The steps of the method 200 illustrate one way in which the steps of the method 100 may be implemented and supplemented in order to achieve the above discussed and additional functionality. As for the method 100 of FIG. 1, the computing node may be operable to run a LwM2M client. The computing node hosts a data object associated with a computational operation that may be executed by the computing node. The data object may conform to an object model specifying resources that may be associated with the data object. The object model to which the data object may conform may be specified as part of the LwM2M protocol specification, and the data object may comprise a LwM2M management object. In this illustrated example, it is assumed that a plurality of instances of the data object are hosted at the computing node, each instance associated with a different computational operation. The computing node may also host one or more additional data objects for example relating to sensors, actuators or other capabilities hosted at the computing node.

Referring initially to FIG. 2a, in a first step 202, the computing node may expose one or more resources of a data object that is hosted at the computing node and is associated with a computational operation, which computational operation is executable by the computing node. As discussed above, the computational operation may comprise a complex computational operation such as a machine learning model, or a decision making model, for example. In the illustrated example, the data object conforms to an object model that specifies resources that may be associated with instances of the data object. The computing node may expose all, or only a subset of the resources of the data object hosted on the computing node. The exposed responses may be exposed with a “read only” interface, such that a server node may only read a value of the resources but may not write to them, or may be exposed with a “read/write” interface. The computing node may expose the one or more resources by registering with a Resource Directory function, or by responding to a discovery request.

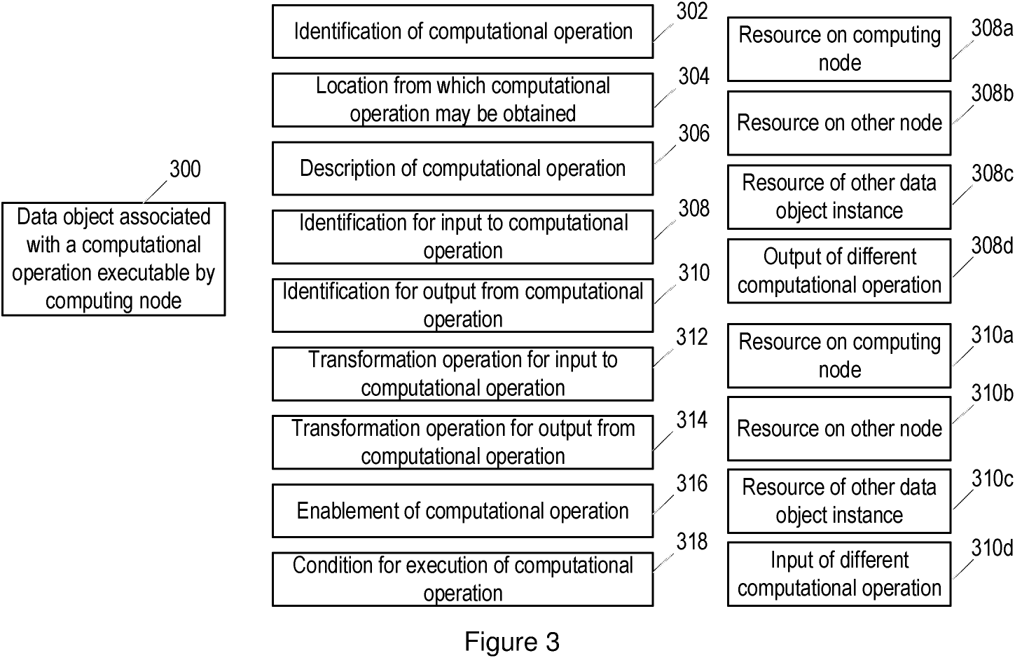

FIG. 3 illustrates examples of resources of the data object 300 that may be present on the computing node performing the method 200. Any one or more of these resources may be exposed at step 202. As discussed above, any one or more of the resources illustrated in FIG. 3 may be present on the computing node but not exposed in step 202.

Referring to FIG. 3, a resource 302 of the data object 300 may identify the computational operation with which the data object is associated. The resource may for example include as a resource value a representation of the operation in a data format, which may be an Intermediate Representation (IR), a Machine Learning (ML) library format or any other ML framework supported by the runtime of the computing node. For example, an ML framework may comprise ONNX, Tensor Flow, PyTorch, or ML algorithms implemented in scripts, such as Python. The identification of the computational operation may comprise an executable representation of the computational operation, for example, a binary representation of the computational operation.

A further resource 304 of the data object 300 may specify a location, such as a Uniform Resource Locator (URL), from which the computational operation may be obtained.

A further resource 306 of the data object 300 may include a description of the computational operation, which may for example be in a non-executable format.

Further resources 308 and 310 of the data object may comprise a resource identification for an input and an output of the computational operation. In some examples, a resource identification may comprise an address that points to a local resource at the computing node (such as a temperature sensor of the computing node, or a setpoint actuator of the computing node). In some examples, a resource identification for an input or an output of the computational operation may therefore comprise an identification of a resource that is hosted on at the computing node, as illustrated at 308a, 310a. In other examples, a resource identification may comprise an address that points to a resource that is external to the computing node (such as an arbitrary source of humidity data, or a setpoint of a home automation system). In such examples, a resource identification for an input or an output for the computational operation may therefore comprise an identification of a resource that is hosted on a node other than the computing node, as illustrated at 308b, 310b. In still further examples, a resource identification for an input or an output for the computational operation may comprise an identification of a resource that is of another instance of the data object that is hosted at the computing node, as illustrated at 308c, 310c. The other instance of the data object may be associated with a different computational operation.

In some examples, a resource identification for an input for the computational operation may identify a resource that comprises an output for a different computational operation, as illustrated at 308d. For example, the resource identification for the input resource may comprise an address pointing to a resource that comprises an output for a different computational operation. It will be appreciated that this may allow the computing node to map one or more outputs of a different computational operation to one or more inputs of the computational operation that is associated with the data object. This may enable the chaining of computational operations by the computing node, by allowing the outputs of the different computational operation to be used as inputs for the computational operation that is associated with the data object.

In further examples, a resource identification for an output for the computational operation may identify a resource that comprises an input for a different computational operation, as illustrated at 310d. For example, the output resource identification may comprise an address pointing to a resource that comprises an input for a different computational operation. It will be appreciated that this may allow the computing node to map one or more outputs of the computational operation that is associated with the data object, to one or more inputs of a different computational operation. This may also enable the chaining of computational operations by the computing node, by allowing the outputs of the computational operation that is associated with the data object to be used as inputs for the different computational operation.

As illustrated at 312, a further resource of the data object 300 may comprise a transformation operation for an input of the computational operation or for an output of the computational operation. A transformation operation for an input may comprise a computational operation to be performed on a resource value identified as an input to the computational operation before the resource value is input to the computational operation. For example, a transformation operation may allow a resource value identified as an input to the computational operation to be transformed to a format or data range that is compatible with the computational operation. Unit conversion may also or alternatively be achieved using a transformation operation. A transformation operation for an output may comprise a computational operation to be performed on an output value of an output for the computational operation before the output value is written to a resource identified for the output for the computational operation. The output of the computational operation may for example be transformed from a computational operation specific format, to a resource specific format.

As illustrated at 314, a further resource of the data object 300 may comprise a computational operation identifier for an input or an output of the computational operation. The computational operation identifier may be referred to as a label, and may contain as a value an input identifier or output identifier that is expressed in the semantics of the computational operation. The computational operation identifier resource may permit a mapping between a resource value identified in an input or output identification resource and a particular input or output of the computational model, to which the identified resource corresponds.

The data object 300 may further comprise an enablement resource 316 that indicates whether or not execution of the computational operation is enabled.

The data object 300 may further comprise a condition resource 318. In some examples, the value of the condition resource may indicate a condition for execution of the computational operation. In some examples, the condition may comprise an operation for evaluation of at least one of a value or state of a resource hosted at the computing node, a value or state of a resource hosted on a node other than the computing node, a state of the computing node or a message received by the computing node. The resources hosted at the computing node whose values may be assessed for the condition may be resources identified as inputs or outputs for the computational operation.

Additional resources may also be included in the data object 300, as discussed with reference to different implementation examples below.

As discussed above, any one or more of the resources discussed above, and/or illustrated in FIG. 3, may be included in the data object hosted at the computing node conducting the method 200. Any one or more of the resources of the data object may be exposed by the computing node in step 202.

Referring again to FIG. 2a, in step 204, the computing node receives a message comprising configuration information for a resource of the data object that is hosted at the computing node and is associated with the computational operation executable by the computing node. The received configuration information may be for a resource that has been exposed by the computing node, or may be for a resource that has not been exposed. The configuration information may in some examples include configuration information for a resource that does not yet exist on the computing node.

It will be appreciated that the configuration information, and the resource to be configured according to the configuration information, may vary according to different implementations of the method 200. Several examples are shown in FIG. 2a for the purposes of illustration, but other examples of configuration information and resources to be configured by the information may be envisaged, including any combination of the information and resources discussed above.

As shown in FIG. 2a, the configuration information may identify the computational operation, as illustrated at 204a, may specify a location from which the computational operation may be obtained, as illustrated at 204b, and/or may comprise a description of the computational operation, as illustrated at 204c. The configuration information may in such examples permit the provisioning of a computational operation for execution by the computing node.

In further examples, the configuration information may comprise at least one of a resource identification, a transformation operation, and/or a computational operation identification for at least one of an input or an output for the computational operation, as illustrated at 304d. The configuration information may additionally or alternatively comprise a value for an enablement resource or a condition resource, as illustrated at 304e. In such examples, the configuration information may permit the configuring of a computational operation for execution by the computing node. The computational operation that is configured may be a computational operation that has been provisioned using additional configuration information, or may already be stored and/or natively running on the computing node. It will be appreciated that, in an implementation in which, for example, input and/or output resources are exposed by the computing node, but are not configured via the received configuration information, a server node may still advantageously configure another resource of the data object via the configuration information on the basis of the exposed resources. For example, a server node may send configuration information for an enablement resource, or a condition resource, wherein such information has been determined on the basis of an exposed input and/or an exposed output resource.

In step 206, the computing node configures a resource of the data object on the computing node in accordance with the received configuration information. It will be appreciated that, if the resource is already hosted at the computing node, the step of configuring the resource on the computing node may comprise updating a value of the resource in accordance with the received configuration information. Alternatively, if the resource does not already exist at the computing node, the step of configuring the resource on the computing node may comprise creating the resource on the computing node in accordance with the received configuration information, for example creating a resource to which an output of the computational operation will be written.

As discussed above, in some examples, the configuration information may comprise one or more labels, wherein the labels indicate which value of a resource identified as an input or output corresponds to which input (or which output) of the computational operation. It will be appreciated that by updating (or creating) a value of a resource in accordance with the received configuration information, when the configuration information comprises a resource value identified as an input to the computational operation, this may allow the computing node to map the resource (whether local or external), to an input of the computational operation that is associated with the data object.

It will be also be appreciated that by updating (or creating) a value of the resource in accordance with the received configuration information, when the configuration information comprises a resource value identified as an output of the computational operation, this may allow the computing node to map an output of the computational operation that is associated with the data object to the resource (whether local or external).

It will also be appreciated that by updating (or creating) a value of a resource in accordance with the received configuration information, when the configuration information comprises a resource identification for an input for the computational operation that identifies a resource that comprises an output for a different computational operation, this may allow the computing node to map an output of a different computational operation to an input of the computational operation that is associated with this data object. This may enable the chaining of computational operations by the computing node.

It will also be appreciated that by updating (or creating) a value of a resource in accordance with the received configuration information, when the configuration information comprises a resource identification for an output for the computational operation that identifies a resource that comprises an input for a different computational operation, this may also allow the computing node to map one or more outputs of the computational operation that is associated with this data object, to one or more inputs of a different computational operation. This may enable the chaining of computational operations by the computing node.

Different computational operations may therefore be chained through the identification of resources written to input and output resources for the computational operation. The different computational operations may be computational operations for execution by other computing nodes, or for execution by the computing node and associated with a different instance of the computational operation data object.

As discussed above, in some examples of the present disclosure, the computational operation may be provisioned using the configuration information received at step 204. The configuration information may comprise an executable representation of the computational operation, which may be a binary representation of the computational operation or a representation a data format such as an Intermediate Representation, a Machine Learning (ML) library format or any other ML framework supported by the runtime of the computing node. For example, an ML framework may comprise ONNX, Tensor Flow, PyTorch, or ML algorithms implemented in scripts, such as Python. In other examples, the configuration information may comprise a location such as a URL from which the computational operation may be obtained, or may comprise a description of the computational operation, for example in a format that is not executable by the computing node. The computing node may therefore perform one of more steps to obtain an executable representation of the computational operation at step 208. Different examples for this obtaining step are illustrated in FIGS. 2b and 2c.

FIGS. 2b and 2c illustrate processes 1000, 1100 which may take place in order to carry out the step 208 of obtaining an executable version of the computational operation.

FIG. 2b illustrates an example in which the received configuration information specifies a location from which the computational operation (such as an ML model) may be obtained. Thus, in the example process 1000, at step 1002, the computing node obtains the computational operation from the specified location. For example, the location may comprise a URL where the model, or an executable representation of the ML model, is stored. In other examples, the location may comprise a URI with additional location information.

In step 1004, the computing node stores a representation of the obtained computational operation by writing the representation to a resource associated with the instance of the computational operation data object hosted at the computing node. It will be appreciated that this “writing” operation may comprise an internal process of writing the obtained computational operation to a memory location corresponding to the relevant resource. This “writing” operation is therefore different to a “Write” operation that may be defined in a protocol such as LwM2M, in which a server may write a value to a resource hosted on a client.

It will be appreciated that, in some examples, the configuration information may specify a location from which an updated computational operation may be obtained (for example, when a version of the computational operation is already hosted at the computing node). In some examples, a resource of the data object hosted at the computing node may be associated with an update time, after which the computing node should check whether or not an updated computational operation exists. A time value in seconds may be written to this resource. For example, writing the time value “3600” to this resource would cause the computing node to check for an updated computational operation at the specified location an hour after the time value had been written to this resource. In another example, writing the time value “0” to this resource would cause the computing node to check for an updated computational operation at the specified location immediately after the time value had been written to this resource.

It will be appreciated that in some examples, the updated computational operation may comprise a patch computational operation. On obtaining this patch computational operation, the computing node may then be able to use this patch computational operation to update the instance of the computational operation that is stored at the computing node. A patch computational operation may be appropriate, for example, in a situation in which bandwidth use is limited, in order to reduce the amount of data to be fetched by the computing node. Additionally or alternatively, a patch computational operation may be appropriate in a situation in which security concerns exist with regard to information exposure.

FIG. 2c illustrates an example in which the received configuration information comprises a description of the computational operation. Thus, in the example process 1100, at step 1102, the computing node obtains an executable representation of the computational operation. It will be appreciated that, in some examples, the representation of the computational model that is obtained may be an updated version of a computation operation that has already been stored in, or that has been executed by the computing node.

In some examples, the computing node may obtain an executable representation of the computational operation by updating the description of the computational operation to an executable representation of the computational operation, as illustrated at step 1102a. In some examples, the step of updating the description of the computational operation may comprise compiling the description into an executable form at the computing node. In other examples, the step of updating the description of the computational operation may comprise interpreting the description. For example, the description may comprise a Python script that requires additional code at the beginning and/or the end of the script in order to be executable by the computing node. In another example, the computational operation may be in a generic form, and may therefore need input and output labels to be added in order for the computational operation to be executable by the computing node.

Alternatively, in some examples, the computing node may obtain an executable representation of the computational operation by sending a request message requesting an update of the description of the computational operation to an executable representation of the computational operation, and receiving a response to the request message, as illustrated in step 1102b. It will be appreciated that the request message may be sent to any other node or function operable to perform the required update.

At step 1104, the computing node stores the executable representation of the computational operation by writing the executable representation to a resource of the instance of the computational operation data object hosted at the computing node.

Referring both to FIG. 2b and FIG. 2c, in some examples, the computing node may check an integrity of the obtained computational operation. In some examples, the computing node may check an integrity of the obtained computational operation by performing a cryptographic operation on a representation of the operation, and comparing a result of the cryptographic operation to a value of a computational operation integrity resource associated with the instance of the computational operation data object that is hosted at the computing node.

Referring again to FIG. 2a, the computing node may instantiate the computational model at step 210. This step may be appropriate if the received configuration information has provisioned the computational operation, by providing a representation of the computational operation, a location from which it may be obtained or a description of the computational operation. In such examples, the computational operation would not already be instantiated and running on the computing node. In examples in which the computational operation is already hosted at the computing node, or is natively defined in the computing node, such that the configuration information may only enable and configure the native computational operation, the instantiating step 210 may be omitted.

At step 212, the computing node detects whether a value of a resource identified as an input for the computational operation has changed. If the value of the resource has changed, the method moves to step 214. If a value of the resource has not changed, the method returns to step 212. For example, if the current value of a temperature sensor of the computing node is identified as an input for the computational operation, and the current value of the temperature sensor updates, the computing node may attempt to execute the computational operation, subject to further checks on enablement and condition resources, as discussed below.

In the illustrated example, at step 214, the computing node determines whether or not a condition for execution of the computational operation is fulfilled, in accordance with a condition resource of the data object. The condition resource may for example have been configured in step 206. If it is determined that the condition is not fulfilled, the method 200 proceeds to step 216, performing at least one of postponing or cancelling execution of the computational operation. If it is determined that the condition is fulfilled, the method 200 proceeds to step 218.

As illustrated at step 214a, the condition may comprise an operation for evaluation of at least one of: a value or state of a resource hosted at the computing node, a value or state of a resource hosted on a node other than the computing node, a state of the computing node and/or a message received by the computing node. Thus, any combination of a value or state of a resource hosted at the computing node, a value or state of a resource hosted on a node other than the computing node, a state of the computing node, and/or a message received by the computing node may be evaluated. In some examples, the resources whose values are evaluated for the condition for execution may be resources that have been identified as inputs and/or outputs of the computational operation. As illustrated at 214ai, the computing node may modify at least one of an input or an output to the computational operation on the basis of a result of the evaluation. This modification may be indicated with an address (such as a URL), for example. In the following temperature based example, an input is selected according to a result of the evaluation:

Condition: if (threshold(Temp, >10))
then input = url1
else
input = url2

In the above example, it may be envisaged that url1 uses a local battery operated sensor reading of high precision, and url2 uses a general temperature sensor reading fetched from a network.

As illustrated at 214aii, the computing node may select a computational operation for execution on the basis of a result of the evaluation. For example, where multiple implementations or versions of the computational operation are available, and where each implementation or version is capable of achieving a different level of performance, one of these implementations may be selected on the basis of a result of the evaluation.

In some examples, in which an enablement resource is present, the computing node may determine whether or not execution of the computational operation is enabled. If execution of the computational operation is not enabled, the computing node may perform at least one of postponing or cancelling execution of the computational operation. In some examples the value of the enablement resource may be automatically updated or changed according to some condition. It will be appreciated that the value of the enablement resource in such examples be other than a binary representation, and may instead comprise a logical expression. Referring again to the above discussed temperature based example, it may be envisaged that a computational operation such as a model has an associated temperature range within which the model is valid. If a temperature reading is over a certain threshold, for example indicating the presence of a fire, the model may no longer be valid, and the enablement resource may be used to deactivate the model. In further examples, a model may be activated only when there is high temperature, or only if a certain input object is available, such as a high precision temperature sensor, without which the model may not be used. In a still further example, following a model update that degrades performance, execution of the model may be disabled using the enablement resource until the model has been updated with an improved alternative.

In step 218, the method 200 comprises executing the computational operation in accordance with the configured resource. In some examples, the step of executing the computational operation in accordance with the configured resource may comprise executing the computational operation in accordance with all the resources of the data object, including the configured resource. In some examples, executing the computational operation in accordance with the configured resource may comprise executing the computational operation, and writing an output of the computational operation to a created or updated output resource.

In some examples, the step of executing the computational operation may comprise executing a transformation operation, which may for example have been received in the configuration information. In some examples, the transformation operation may be executable by the computing node. In other examples, the transformation operation may be executable by another node. In such examples, configuration information for the transformation operation resource may include an address of a node operable to execute the transformation operation. In such examples, the computing node may request the transformation operation be carried out by the other node, and may receive a result of the transformation operation. In some examples, configuration information for the transformation operation resource may specify a location from which the transformation operation may be obtained (such as a URL, for example).

In some examples, following execution of the computational operation, the computing node may return to step 202, and expose one or more resources of the data object, which resources may for example include the resource for which the configuration information was received at step 204. The computing node may then repeat some or all of the method 200.

In some examples, a first execution of the method 200 may have resulted in the creation of resources for which configuration information was received. These resources may then be exposed and may be configured in their turn via the receipt of new configuration information. As discussed above, the computing node may expose at least one resource of a data object that is hosted at the computing node by registering the resource of the data object with a resource directory function, or by receiving a discovery message requesting identification of computing nodes that have exposed at least one resource of a data object associated with a computational operation, and responding to the discovery message with an identification of the computing node and the resource.

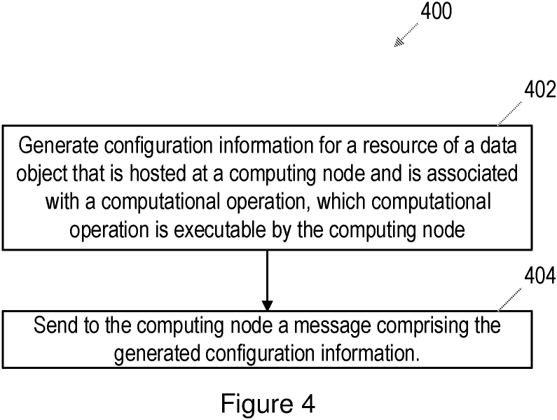

FIG. 4 is a flowchart illustrating process steps in a method 400 for operating a server node in accordance with aspects of the present disclosure. The method is performed by the server node, which may be operable to run a LwM2M server. The method 400 may complement the method 100 and/or 200.

Referring to FIG. 4, the method 400 comprises, in a first step 402, generating configuration information for a resource of a data object that is hosted at a computing node and is associated with a computational operation, which computational operation is executable by the computing node. The data object may conform to an object model, which model may be specified as part of the LwM2M protocol specification. The data object may for example comprise a LwM2M management object.

In step 404, the server node sends to the computing node a message comprising the generated configuration information.

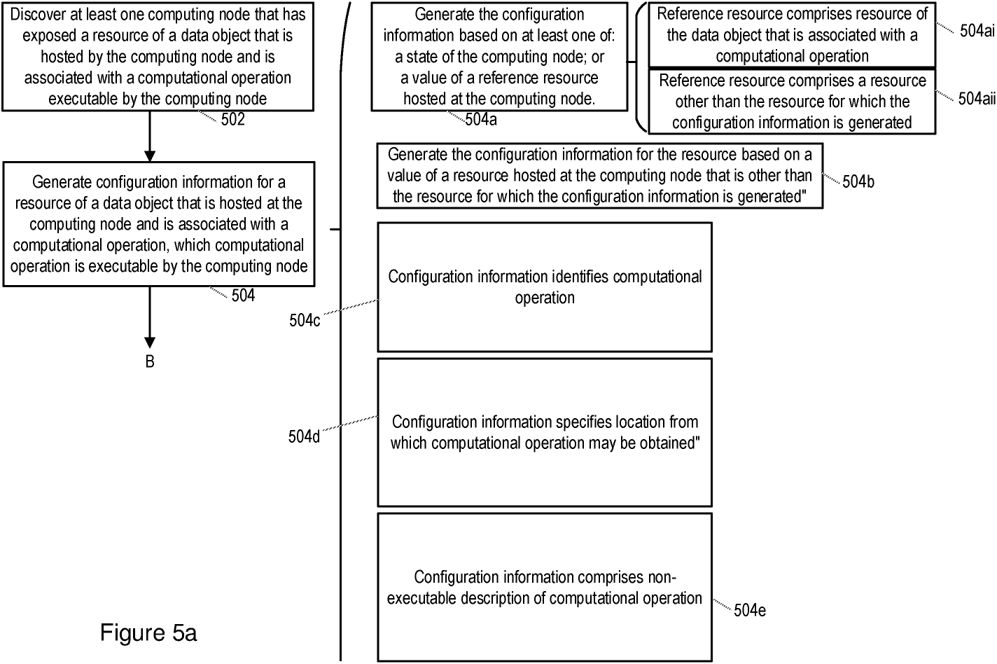

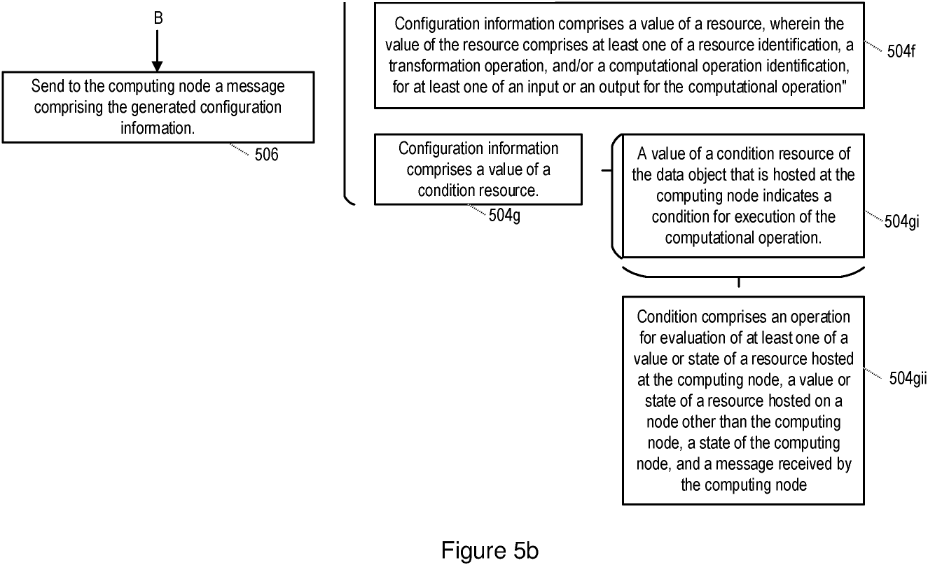

FIGS. 5a and 5b show a flow chart illustrating process steps in another example of a method 500 for operating a server node in accordance with aspects of the present disclosure. The method is performed by the server node, which may be operable to run a LwM2M server. The steps of method 500 illustrate one way in which steps of the method 400 may be implemented and supplemented in order to achieve the above discussed and additional functionality.

Referring firstly to FIG. 5a, the method 500 may comprise, in a first step 502, discovering at least one computing node that has exposed a resource of a data object that is hosted by the computing node and is associated with a computational operation executable by the computing node. This discovery step may be performed by sending a discovery message to at least one of a resource directory function, and/or a multicast address for computing nodes.

In step 504, the server node generates configuration information for a resource of a data object that is hosted at the computing node and is associated with a computational operation, which computational operation is executable by the computing node. The data object may comprise a data object 300 as illustrated in FIG. 3, and may comprise any one or more of the resources illustrated in FIG. 3, and/or discussed above with reference to FIGS. 2a to 2c or 3.

As illustrated at step 504a, the server node may generate the configuration information based on at least one of a state of the computing node, and/or a value of a reference resource hosted at the computing node. In some examples, the reference resource comprises a resource of the data object that is associated with a computational operation. As illustrated at step 504ai, the reference resource may comprise a resource that is associated with an input of the computational operation. As illustrated at step 504aii, the reference resource may comprise a resource other than the resource for which the configuration information is generated. For example, configuration information for a condition or enablement resource may be generated based on a reference resource that comprises an input and/or output resource for the computational operation.

In other examples, the step of generating the configuration information may comprise generating the configuration information based on a value of one or more resources hosted at the computing node that are not part of the computational operation data object. For example, a resource hosted at the computing node that is not part of the computational operation data object may comprise a value of a sensor at the computing node. In another example, a resource hosted at the computing node that is not part of the computational operation data object may comprise a state of an actuator at the computing node.

As illustrated at step 504b, the server node may generate the configuration information for a resource based on a value of a resource hosted at the computing node that is other than the resource for which the information is generated.

It will be appreciated that the configuration information may comprise a value of a resource of the data object that is hosted at the computing node, according to any of the examples discussed above.

Referring now to FIG. 5b, as illustrated at step 504c, the configuration information may identify a computational operation. As illustrated at step 504d, the configuration information may specify a location from which the computational operation may be obtained.

The configuration information may identify a computational operation in accordance with any of the examples described above. For example, information identifying the computational operation may comprise a representation of the computational operation in a data format. The representation may comprise an Intermediate Representation, a Machine Learning library format, or any other ML framework that is supported by the runtime of the computing node. For example, an ML framework may comprise ONNX, Tensor Flow, PyTorch, or ML algorithms implemented in scripts, such as Python.

As illustrated at step 502e, the configuration information may comprise a description of the computational operation, which may in some examples be in a non-executable format.

As illustrated at 502f, in some examples, the configuration information comprises a value of a resource, wherein the value of the resource comprises at least one of a resource identification, a transformation operation, and/or a computational operation identification, for at least one of an input or an output for the computational operation. As noted above, in some examples, the transformation operation may be executable by the computing node. In other examples, the transformation may be executable by another node. In this example, the configuration information may include an address of a node operable to execute the transformation operation.

As discussed above, a value of an enablement resource associated with the instance of the computational operation data object that is hosted at the computing node may indicate whether or not execution of the computational operation is enabled, in accordance with the examples described above. The configuration information may additionally or alternatively comprise a value for an enablement resource.

As illustrated at step 504g, the configuration information may comprise a value of a condition resource. As illustrated at step 504gi, in some examples, a value of a condition resource of the data object that is hosted at the computing node may indicate a condition for execution of the computational operation, in accordance with the examples described above. As illustrated at step 504gii, the condition may comprise an operation for evaluation of at least one of a value or state of a resource hosted by the computing node, a value or state of a resource hosted on a node other than the computing node, a state of the computing node, and/or a message received by the computing node.

In step 506, the server node sends to the computing node a message comprising the generated configuration information.

Examples of the present disclosure enable the configuring of a computational operation to be executed by the computing node. The computational operation may be provisioned in the computing node, and/or its execution, including resources to be mapped to inputs and outputs of the computational operation, may be configured in accordance with resources available at the computing node or other computing nodes. This configuration is achieved via resources of a data object that is hosted at the computing node and associated with the computational operation to be executed by the computing node

A structure of an example implementation of the data object proposed in the present disclosure is given in the following table. The data object is hosted at a computing node, and is associated with a computational operation that may be executed by the computing node. It will be appreciated that multiple instances of the data object may be hosted at the computing node, where each instance of the data object is associated with a different computational operation. The example implementation of a data object illustrated below may comprise an implementation of the data object 300, illustrated in FIG. 3.

| ID | Resource name (single/array) | Data type |
|---|---|---|
| 1 | Model (single) | opaque |
| 2 | Version (single) | string |
| 3 | Description URL (single) | string |
| 4 | Model-URI (single) | string |
| 5 | Model Integrity (single) | string |
| 6 | Model-Description (single) | URL; opaque; string; binary |
| 7 | Inputs (array) | CoRE links/URLs |
| 8 | Input transforms (array) | string |
| 9 | Input labels (array) | string |
| 10 | Outputs (array) | CoRE links/URLs |
| 11 | Output transforms (array) | string |
| 12 | Output labels (array) | string |
| 13 | Enabled (single) | Boolean |
| 14 | Condition Expression (single) | string |
| 15 | Implementation Id (single) | string |

In the above table, “single” indicates that one value may be written to the resource, and “array” indicates that a group of related resources exist, where a value may be written to each of these related resources. It will be appreciated that, for a data object hosted at a computing node, not all resources of the data object hosted at the computing node may exist. It will also be appreciated that the computational operation may comprise a complex computational operation such as a machine learning model, or a decision-making model, for example.

The “Model” resource comprises a representation of the computational operation that is executable by the computing node. For example, the “Model” resource may comprise a binary representation of the computational operation. When an executable representation of the computational operation is written to this resource, this executable representation may be executed by the computing node when the “Enabled” resource comprises a value that indicates that execution of the representation of the computational operation is enabled.

The “Version” resource comprises a value indicating the current version of the computational operation that is being referred to.

The “Description” resource specifies a location that describes the operation executed by the computational operation (for example, a URL). This information may also describe metadata related to the input(s) and/or output(s) of the computational operation. This information may be readable by the computing node to enable automatic orchestration of the computational operation by the computing node. For example, the description may comprise standardised vocabularies and description languages (for example, a Web of Things, WoT, thing description).

The “Model-URI” resource specifies a location from which the computational operation may be obtained (for example, a URL). Additionally or alternatively, the resource may comprise a description of the computational operation (for example, a URI) which may then be retrieved by the computing node. This description may identify the computational operation. When this resource is written to, the computing node may attempt to obtain an executable representation of the computational operation, and may store this representation at the “Model” resource.

The “Model Integrity” resource comprises a cryptographic checksum of the obtained computational operation, which may be used for checking the correctness and/or the integrity of the obtained computational operation.

The “Model Description” resource comprises a description of the computational operation (for example, an ONNX file). When a description of the computational operation is written to this resource, the computing node may send a request message requesting an update of the description of the computational operation to an executable representation of the computational operation. Additionally or alternatively, the computing node may attempt to update the description to an executable representation of the computational operation, for example by compiling or interpreting the description. Additionally or alternatively, the computing node may attempt to execute the computational operation in its native form. If an update is performed, the executable representation of the computational operation may be stored at the “Model” resource. Updating may comprise compiling the computational operation, interpretation the computational operation, etc.

The “Input” resources comprise a plurality of addresses (for example, a plurality of CoRE links, or a plurality of URLs) that point to local resources at the computing node (for example “</3303/1/5700>” will point to the current value of the first instance of a temperature sensor at the computing node), or that point to external resources (for example, “coap://foo.example/humidity” will point to an arbitrary source of humidity data). In other words, the “Input” resources allow the computing node to identify one or more local and/or external resources to be used as inputs of the computational operation that is associated with this data object.

The “Input” resources may additionally or alternatively comprise one or more addresses pointing to one or more “Output” resources of a further instance of the data object that is associated with a different computational operation. In other words, an output of a different computational operation may be used as an input for the computational operation that is associated with the data object, so allowing for chaining of computational operations.

The “Input transform” resources comprise descriptions of the transformation operations for transforming a value written to a local resource, or a value written to an external resource, to a format that is compatible with the computational operation. For example, a transformation operation may comprise an arithmetic expression such as normalisation, or may comprise a script.

The “Input labels” resource comprises one or more labels which describe which of the “Input” resource addresses match to which input of the computational operation. For example, the first label may correspond to the first input of the computational model, and match to the first “Input” resource. In other words, the “Input labels” resource allows the computing node to map one or more local and/or external resources identified as inputs to one or more inputs of the computational operation that is associated with this data object.

The “Outputs” resources comprise a plurality of addresses (for example, a plurality of CoRE links, or a plurality of URLs) that point to local resources at the computing node (for example “</3308/1/5900>” will point to the set point value of the first instance of the set point actuator at the computing node), or that point to external resources (for example, “coap://foo.example/ac-setpoint” will point to the set point of a home automation system). In other words, the “Output” resources allow the computing node to identify one or more local and/or external resources to which outputs of the computational operation that is associated with this data object should be written.

The “Output” resources may additionally or alternatively comprise one or more addresses pointing to one or more “Input” resources of a further instance of the data object that is associated with a different computational operation. In other words, an output of the computational operation that is associated with the data object may then be used as an input for a different computational operation, so achieving chaining of computational operations.

The “Output transform” resources comprise descriptions of transformation operations for transforming the output of the computational operation to a format that is suitable to be written to a local resource, or to an external resource. In other words, the output of the computational operation may be transformed from a computational operation specific format, to a resource specific format. For example, a transformation operation may comprise an arithmetic expression, or may comprise a script. The output transformation may correspond to an input transformation to be performed on an input to the computational operation.

The “Output labels” resource comprises one or more labels which describe which of the “Output” resources addresses match to which output of the computational operation. For example, the first label may correspond to the first output of the computational model, and match to the first “Output” resource. The “Output labels” resource may therefore enable mapping of computational operation output to a resource to which that output should be written.

The “Enabled” resource comprises a value indicating whether the computational operation is enabled to be executed by the computing node. For example, the value “true” may indicate that the computational operation is enabled to be executed by the computing node. The value “false” may indicate that the computational operation is not enabled to be executed by the computing node.

The “Condition expression” resource comprises an expression for triggering the execution of the computational operation. In other words, if this expression is fulfilled, the computing node may execute the computational operation. If no expression is written to this resource, the computational model will be executed each time one of the “Input” resource values changes. In some examples, if an expression is written to this resource, the values of the “Input” resource may be evaluated according to the expression. The computational operation may or may not be executed by the computing node as a result of this evaluation.

The “Implementation Id” resource comprises an identifier of a specific implementation of a version of the computational operation. This resource may be used when multiple implementations of a version of the computational operation are available, for example, where each implementation is capable of achieving a different level of performance.

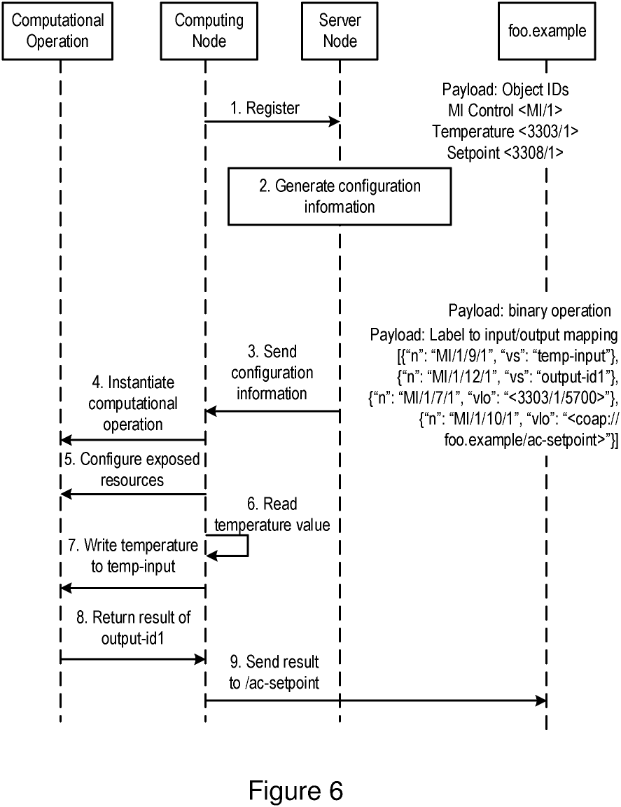

FIG. 6 is a signalling diagram illustrating an example implementation of the methods 200, 400. Referring to FIG. 6, in step 1, a computing node transmits a registration request to a server node. In this illustrated example, the registration request comprises information identifying three data objects hosted at the computing node. A first data object (“MI”) is associated with a computational operation executable by the computing node. The second and third data objects are standard IPSO temperature (3303) and setpoint (3308) objects at the computing node. In the illustrated example, all objects have one instance.

In step 2, the server node generates configuration information for the MI object. In this illustrated example, the configuration information identifies the computational operation, identifies an input resource and an output resource, and provides labels mapping input and output resources to input and outputs of the computational operation. The configuration information comprises:
A binary representation of the computational operation to be written to the “Model” resource of the MI data object
The identifier “3303/1/5700” to be written to the “Input” resource of the MI data object. In this example, this identifier corresponds to the current value of the temperature sensor at the computing node.
The identifier “coap://foo.example/ac-setpoint” to be written to the “Output” resource of the data object. In this example, this address points to a value of the setpoint of a home automation system.
The label “temp-input” to be written to the “Input label” resource of the data object.
The label “output-id1” to be written to the “Output label” resource of the data object.

The generated configuration information thus configures the computational operation to use the current value of the temperature sensor at the computing node as the input to the computational operation, and the server further configures the output of the computational operation to be written to the setpoint of the home automation system.

In step 3, the server node sends to the computing node a message comprising the generated configuration information, so provisioning the computational operation and configuring its execution on the computing node. It will be appreciated that, in other examples, the computational operation may instead be provisioned using the “Model URI”, or the “Model Description” resources. In such examples, the configuration information that is provisioned to the computing node by the server node may specify a location from which the computational operation may be obtained, or may comprise a non-executable description of the computational operation. In some examples, the configuration information may be sent in two separate messages, a first message to provision the computational operation and a second message to configure the execution of the computational operation.

In step 4, the computing node instantiates the identified computational operation. It will be appreciated that, depending on the configuration information that is received by the computing node, the computing node may instantiate the identified computational operation according to any suitable method as described above.

In step 5, the computing node configures resources of the MI data object in accordance with the received configuration information.

In steps 6, 7, 8 and 9, the computational operation is executed by the computing node in accordance with the configured resource. In step 6, the computing node reads the current value of the temperature sensor at the computing node, in accordance with the address written to the “Input” resource of the data object. In step 7, the computing node writes the obtained value of the temperature sensor to the input of the computational operation “temp-input”, in accordance with the label written to the “Input label” resource of the data object. The computational operation is then executed by the computing node, and at step 8, the output of the computational operation is returned, labelled with the label “output-id1”. At step 9, the computing node writes the output of the computational operation to the location pointed to by the address “coap://foo.example/ac-setpoint”, in accordance with the address written to the “Output” resource of the data object.

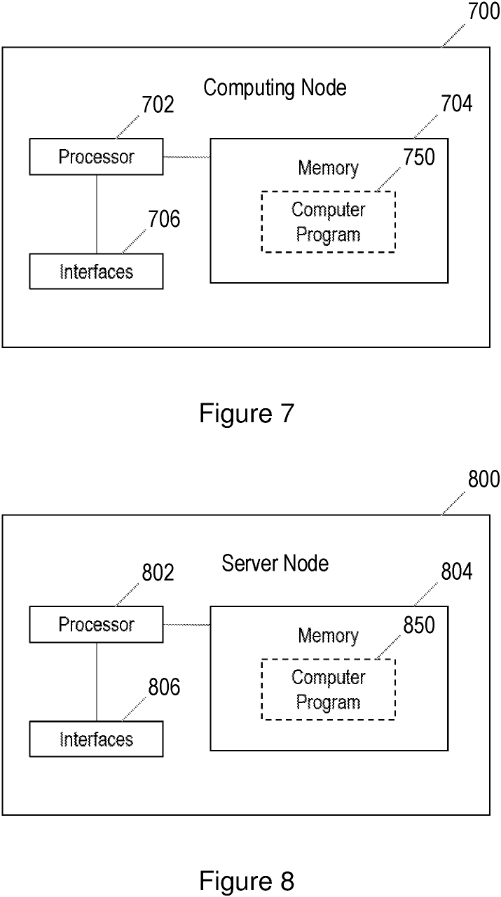

As discussed above, the methods 100 and 200 may be performed by a computing node. The computing node may be operable to run a LwM2M client, and may host one or more data objects (for example, the data object described above). FIG. 7 is a block diagram illustrating an example computing node 700 which may implement the methods 100 and 200 according to examples of the present disclosure, for example on receipt of suitable instructions from a computer program 750. Referring to FIG. 7, the node 700 comprises a processor or processing circuitry 702, a memory 704 and interfaces 706. The memory 704 contains instructions executable by the processor 702 such that the node 700 is operative to conduct some or all of the steps of the method 100 and/or 200. The instructions may also include instructions for executing one or more telecommunications and/or data communications protocols. The instructions may be stored in the form of the computer program 750. In some examples, the processor or processing circuitry 702 may include one or more microprocessors or microcontrollers, as well as other digital hardware, which may include digital signal processors (DSPs), special-purpose digital logic, etc. The processor or processing circuitry 702 may be implemented by any type of integrated circuit, such as an Application Specific Integrated Circuit (ASIC), Field Programmable Gate Array (FPGA) etc. The memory 704 may include one or several types of memory suitable for the processor, such as read-only memory (ROM), random-access memory, cache memory, flash memory devices, optical storage devices, solid state disk, hard disk drive etc.

As discussed above, the methods 400 and 500 may be performed by a server node. The server node may be operable to run a LwM2M server. FIG. 8 is a block diagram illustrating an example server node 800 which may implement the methods 400 and 500 according to examples of the present disclosure, for example on receipt of suitable instructions from a computer program 850. Referring to FIG. 8, the node 800 comprises a processor or processing circuitry 802, a memory 804 and interfaces 806. The memory 804 contains instructions executable by the processor 802 such that the node 800 is operative to conduct some or all of the steps of the method 400 and/or 500. The instructions may also include instructions for executing one or more telecommunications and/or data communications protocols. The instructions may be stored in the form of the computer program 850. In some examples, the processor or processing circuitry 802 may include one or more microprocessors or microcontrollers, as well as other digital hardware, which may include digital signal processors (DSPs), special-purpose digital logic, etc. The processor or processing circuitry 802 may be implemented by any type of integrated circuit, such as an Application Specific Integrated Circuit (ASIC), Field Programmable Gate Array (FPGA) etc. The memory 704 may include one or several types of memory suitable for the processor, such as read-only memory (ROM), random-access memory, cache memory, flash memory devices, optical storage devices, solid state disk, hard disk drive etc.

Examples of the present disclosure thus provide methods for operating a computing node, and for operating a server node, that enable configuration of a computational operation executable by the computing node. Examples of the present disclosure enable such configuration via a data object that is associated with the computational operation. The data object comprises resources via which the sever node may provision a computational operation to the computing node, and/or enable a computing node to configure how the computational operation uses or writes to different resources at the computing node or other nodes. For example, the data object may enable the computing node to configure how the inputs and/or the outputs of the computational operation are connected to resources of the computing node. Furthermore, the data object may enable the computing node to chain the output of the computational operation to the input of a different computational operation, and/or the data object may enable the computing node to chain the input of the computational operation to the output of a different computational operation. An object model to which the data object conforms may be specified as part of the LwM2M protocol specification, and the data object may comprise a LwM2M management object. The object model may be considered an extension to the LwM2M protocol.

It will be appreciated that the data object may enable the sever node to provision a computational operation to the computing node, and/or enable a computing node to configure how the computational operation is connected to different resources at the computing node, independently of the computing node, and independently of the resources at the computing node. It will be appreciated that the data object may provide an interface for mapping the inputs and/or outputs of a computational operation to the resources at a computing node (in order to use local information), and/or to different computational operations (in order to enable computational operation chaining). The data object may be considered to provide a standard interface for configuring computational operations on computing nodes, avoiding the need for a firmware update. The data object may be configured in a manner that is consistent across different types of computing nodes, which may for example have access to different resources.

Advantageously, the resources that are configured in accordance with configuration information received in accordance with the present disclosure do not need to exist prior to the configuration of the resources by the computing node. In addition, the computing node does not need to be aware of the resource identifiers (in other words, the semantics of the resources), in order to create the resources based on the resource identifiers. Examples of the data object proposed herein thus enable “automatic” provision of new semantics for the resources available at the computing node to the server node, which the server node may then use.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-44. (canceled)

45. A computing node operable to run a Lightweight Machine to Machine client and comprising processing circuitry configured to cause the computing node to:
receive a message comprising configuration information for a resource of a data object that is hosted at the computing node and is associated with a computational operation which comprises a machine learning model, which computational operation is executable by the computing node;
configure the resource of the data object on the computing node in accordance with the received configuration information; and
execute the computational operation in accordance with the configured resource.

46. A computing node as claimed in claim 45, wherein the processing circuitry is further configured to cause the computing node to:
expose the resource of the data object for which the configuration information is received.

47. A computing node as claimed in claims 45, wherein the configuration information identifies the computational operation, and wherein the processing circuitry is further configured to cause the computing node to:
instantiate the identified computational operation.

48. A computing node as claimed in claims 45, wherein the configuration information specifies a location from which the computational operation may be obtained, and wherein the processing circuitry is further configured to cause the computing node to:
obtain the computational operation from the specified location.

49. A computing node as claimed in claim 45, wherein a value of a resource of the data object that is hosted at the computing node comprises at least one of:
a resource identification;
a transformation operation;
a computational operation identification
for at least one of an input or an output of the computational operation.

50. A computing node as claimed in claim 49, wherein at least one of:
a resource identification for an input for the computational operation; or
a resource identification for an output for the computational operation comprises an identification of a resource that is:
hosted on a node other than the computing node; or
of another instance of the data object that is hosted at the computing node.

51. A computing node as claimed in claim 49, wherein at least one of:
a resource identification for an input for the computational operation identifies a resource that comprises an output for a different computational operation; or
a resource identification for an output for the computational operation identifies a resource that comprises an input for a different computational operation.

52. A computing node as claimed in claim 49, wherein a transformation operation comprises a computational operation to be performed on either:
a resource value identified as an input to the computational operation before the resource value is input to the computational operation; or
an output value of an output for the computational operation before the output value is written to a resource identified for the output for the computational operation.

53. A computing node as claimed in claim 49, wherein the configuration information comprises a value of at least one of:
a resource identification;
a transformation operation;
a computational operation identification
for at least one of an input or an output of the computational operation.

54. A computing node as claimed in claim 45, wherein a value of a condition resource of the data object that is hosted at the computing node indicates a condition for execution of the computational operation, and wherein the processing circuitry is further configured to cause the computing node to:
determine whether the condition is fulfilled; and
if the condition is not fulfilled, perform at least one of postponing or cancelling execution of the computational operation.

55. A computing node as claimed in claim 45, wherein the processing circuitry is further configured to cause the computing node to:
detect a change in a value of a resource identified as an input for the computational operation; and
execute the computational operation.

56. A server node operable to run a Lightweight Machine to Machine server and comprising processing circuitry configured to cause the server node to:
generate configuration information for a resource of a data object that is hosted at a computing node and is associated with a computational operation which comprises a machine learning model, which computational operation is executable by the computing node; and
send to the computing node a message comprising the generated configuration information.

57. A server node as claimed in claim 56, wherein the processing circuitry is further configured to cause the server node to:
discover the computing node as having exposed the resource of the data object for which the configuration information is generated.

58. A server node as claimed in any one of claims 56, wherein the processing circuitry is further configured to cause the server node to generate the configuration information based on at least one of:
a state of the computing node; or
a value of a reference resource hosted at the computing node.

59. A server node as claimed in claim 56, wherein a value of a resource of the data object that is hosted at the computing node comprises at least one of:
a resource identification;
a transformation operation;
a computational operation identification
for at least one of an input or an output for the computational operation.

60. A server node as claimed in claim 59, wherein at least one of:
a resource identification for an input for the computational operation identifies a resource that comprises an output for a different computational operation; or
a resource identification for an output for the computational operation identifies a resource that comprises an input for a different computational operation.

61. A server node as claimed in claim 59, wherein a transformation operation comprises a computational operation to be performed on either:
a resource value identified as an input to the computational operation before the resource value is input to the computational operation; or
an output value of an output for the computational operation before the output value is written to a resource identified for the output for the computational operation.

62. A server node as claimed in claim 46, wherein a value of a condition resource of the data object that is hosted at the computing node indicates a condition for execution of the computational operation.

63. A method for operating a computing node operable to run a Lightweight Machine to Machine client, the method, performed by the computing node, comprising:
receiving a message comprising configuration information for a resource of a data object that is hosted at the computing node and is associated with a computational operation which comprises a machine learning model, which computational operation is executable by the computing node;
configuring the resource of the data object on the computing node in accordance with the received configuration information; and
executing the computational operation in accordance with the configured resource.

64. A method for operating a server node operable to run a Lightweight Machine to Machine server, the method, performed by the server node, comprising:
generating configuration information for a resource of a data object that is hosted at a computing node and is associated with a computational operation which comprises a machine learning model, which computational operation is executable by the computing node; and
sending to the computing node a message comprising the generated configuration information.
